(19) United States
(12) Patent Application Publication
(10) Pub. No.: US 2019/0025524 A1
(43) Pub. Date: Jan. 24, 2019

(54) CLEANER

(71) Applicant: Tomoegawa Co., Ltd, Tokyo (JP)

(72) Inventors: Makoto Goto, Fujieda-shi (JP); Masayoshi Suzuki, Fujieda-shi (JP); Yoshihiro Goto, Shizuoka-shi (JP); Nobuhiro Hashimoto, Shizuoka-shi (JP)

(21) Appl. No.: 16/071,937

(22) PCT Filed: Jan. 23, 2017
(86) PCT No.: PCT/JP2017/002086

§ 371 Date: Jul. 23, 2018

(30) Foreign Application Priority Data
Feb. 1, 2016 (JP) 2016-017096
Oct. 28, 2016 (JP) 2016-211885

(51) Int. Cl. G02B 6/38; B08B 1/00

(52) U.S. Cl. CPC G02B 6/3866; A47L 25/00; B08B 1/005

(57) ABSTRACT

An object of the present invention is to provide a cleaner which is excellent in dust removability, has a small amount of adhesive residue and is able to clean sufficiently over the details of unevenness even when cleaning an end face having unevenness, and the present invention provides a cleaner which is excellent in dust removability, has a small amount of adhesive residue and is able to clean sufficiently over the details of unevenness even when cleaning an end face having unevenness by setting a peeling force of an adhesive body to 0.1 to 10 N/20 mm and a hardness of the adhesive body to 12 to 52.

### TECHNICAL FIELD

The present invention relates to a cleaner for cleaning an end face of optical connector having unevenness or having a fitting pin projectingly provided thereon.

### BACKGROUND ART

The optical connector for connecting the optical fibers is required to have a clean connection end face in order to transmit the optical signal correctly. Therefore, in the working places connecting the optical fibers, operators may have to clean the connection end face with cleaning tools.

As a cleaning tool for cleaning connection end face, for example, Patent Document 1 discloses a pad-like cleaning member having an abutting surface to be brought into contact with the connection end face of the optical connector and having a substrate formed of a resin having flexibility.

Patent Document 2 discloses an optical connector cleaning tool that wipes and cleans the connection end face of the optical connector by feeding and moving a cleaning tape.

Patent Document 3 discloses an optical connector cleaner in which a silicone adhesive is coated on a substrate.

Patent Document 4 discloses a cleaning tool having a handle portion, a pseudo plug portion, a cleaning jig provided with a pseudo ferrule portion extending from the pseudo plug portion, and an adhesive portion on an end face of the pseudo ferrule portion.

### PRIOR ART LITERATURE

### Patent Documents

### [Patent Document 1] Japanese Unexamined Patent Application Publication No. 2002-219421

### [Patent Document 2] Japanese Unexamined Patent Application Publication No. 2004-326054

### [Patent Document 3] Japanese Unexamined Patent Application Publication No. 2008-180799

### [Patent Document 4] Japanese Unexamined Patent Application Publication No. 2013-210404

### DISCLOSURE OF INVENTION

### Problems to be Solved by the Invention

However, the cleaning tool described in Patent Document 1 does not necessarily and sufficiently satisfy the dust removability. Especially, when cleaning an end face of connector having unevenness or cleaning an end face having a pin, such as a fitting pin, projectingly provided thereon, etc., the ability to follow the uneven surface and the peripheral surface of the pin is insufficient and thereby it was difficult to sufficiently clean the detail part of unevenness. Furthermore, after cleaning, adhesive residue sometimes occurred on the connection end face or pin.

The cleaning tools described in Patent Documents 2 to 4 also do not necessarily and sufficiently satisfy the dust removability with regard to the cleaning ability of the end face having unevenness.

An object of the present invention is to provide a cleaner having an excellent dust removability, less adhesive residue and high cleaning ability even when cleaning an end face having unevenness.

Another object of the present invention is to provide a cleaner which can sufficiently clean a peripheral surface of a pin even when cleaning an end face having a pin, such as a fitting pin, projectingly provided thereon.

A further object of the present invention is to provide a method for manufacturing a cleaner having the above described excellent properties.

### Means for Solving the Problems

The present invention provides the following cleaner and method for manufacturing the same.

[1] A cleaner comprising an adhesive body and a holding body configured to hold the adhesive body, wherein a peeling force of the adhesive body is 0.1 to 10 N/20 mm and a hardness of the adhesive body is 12 to 52.

[2] The cleaner according to [1], wherein the adhesive body is formed on a surface of the holding body.

[3] The cleaner according to [1], wherein the adhesive body is configured to be held so that a part of the surface of the adhesive body is exposed.

[4] The cleaner according to any one of [1] to [3], wherein the adhesive body is a cured product of an adhesive agent composition containing a first ultraviolet curable resin having an acryloyl group and being monofunctional, and a second ultraviolet curable resin having a (meth) acryloyl group and being polyfunctional.

[5] The cleaner according to [4], wherein a molecular weight of the first ultraviolet curable resin is less than 200 and a molecular weight of the second ultraviolet curable resin is 200 or more.

[6] The cleaner according to any one of [1] to [3], wherein the adhesive body is a cured product of an adhesive agent composition containing a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.

[7] The cleaner according to any one of [4] to [6], wherein the adhesive agent composition further contains an ultraviolet curing assistant.

[8] The cleaner according to any one of [1] to [7], wherein the cleaner is used for cleaning an end face of optical connector.

[9] The cleaner according to [8], wherein unevenness is provided, or a pin is projected on the end face of the optical connector.

[10] A method for manufacturing a cleaner, comprising a step of disposing an adhesive agent composition on a holding body and curing the adhesive agent composition by irradiating ultraviolet rays to form an adhesive body on a holding body, wherein the adhesive agent composition comprises a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.

[11] A method for manufacturing a cleaner, comprising

a step of applying an adhesive agent composition on a sheet having a transferability and curing the adhesive agent composition by irradiating ultraviolet rays to form an adhesive body on the sheet, and

a step of transferring the obtained adhesive body on a holding body, wherein

the adhesive agent composition comprises a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.

[12] A method for manufacturing a cleaner, comprising a step of disposing an adhesive agent composition on a supporting body and irradiating ultraviolet rays to cure the adhesive agent composition to form an adhesive body on a supporting body, wherein

the adhesive agent composition comprises a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.

[13] A method for manufacturing a cleaner, comprising

a step of applying an adhesive agent composition on a sheet having a transferability and curing the adhesive agent composition by irradiating ultraviolet rays to form an adhesive body on the sheet, and

a step of transferring the obtained adhesive body on a supporting body, wherein

the adhesive agent composition comprises a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.

### Effects of the Invention

According to the cleaner of the present invention, even in the case of cleaning an end face having unevenness, the dust removability is excellent, the amount of adhesive residue is small, and the cleaning ability is sufficient.

Furthermore, even in the case of cleaning an end face having a pin, such as a fitting pin, projectingly provided thereon, the end face as well as the peripheral surface of the pin can be cleaned sufficiently.

Furthermore, according to the method of manufacturing a cleaner of the present invention, it is possible to manufacture a cleaner having the above-described excellent properties.

### BRIEF DESCRIPTION OF THE DRAWINGS

FIG. 1A is a schematic front view showing a cleaner according to the first embodiment.

FIG. 1B is a schematic side view showing a cleaner according to the first embodiment.

FIG. 2 is a perspective view showing a cleaner according to the second embodiment.

FIG. 3A is a perspective view showing a cleaner according to the fifth embodiment.

FIG. 3B is a longitudinal sectional view showing a cleaner according to the fifth embodiment.

FIG. 3C is a perspective view showing an optical connector.

FIG. 4A is a cross-sectional view explaining a method of cleaning an end face of an optical connector having a fitting pin projectingly provided thereon using a cleaner according to the third embodiment, and a cross-sectional view showing a state in which the fitting pin projectingly provided on the end face of the optical connector is pushed into an adhesive body of the cleaner, thereby pressing the end face against the surface of the adhesive body.

FIG. 4B is a cross-sectional view explaining a method of cleaning an end face of an optical connector having a fitting pin projectingly provided thereon using a cleaner according to the third embodiment, and a cross-sectional view showing a state in which the fitting pin is pulled out from the adhesive body.

FIG. 5 is a longitudinal sectional view showing a cleaner according to the fourth embodiment.

FIG. 6 is a perspective view showing a cleaner according to the second embodiment.

FIG. 7A is a perspective view showing a cleaner according to the fifth embodiment.

FIG. 7B is a longitudinal cross-sectional view showing a cleaner according to the fifth embodiment.

FIG. 8A is a cross-sectional view explaining a method of cleaning an end face of an optical connector having a fitting pin projectingly provided thereon using a cleaner of the fifth embodiment, and a cross-sectional view showing a state of peeling off one piece of film.

FIG. 8B is a cross-sectional view explaining a method of cleaning an end face of an optical connector having a fitting pin projectingly provided thereon using a cleaner according to the fifth embodiment, and a cross-sectional view showing a state in which a fitting pin projectingly provided on the end face of the optical connector is pushed into the adhesive body exposed by peeling off the film piece, thereby pressing the end face against the surface of the adhesive body.

FIG. 8C is a cross-sectional view explaining a method of cleaning an end face of an optical connector having a fitting pin projectingly provided thereon using a cleaner of the fifth embodiment, and a cross-sectional view showing a state in which a fitting pin is pulled out from an adhesive body.

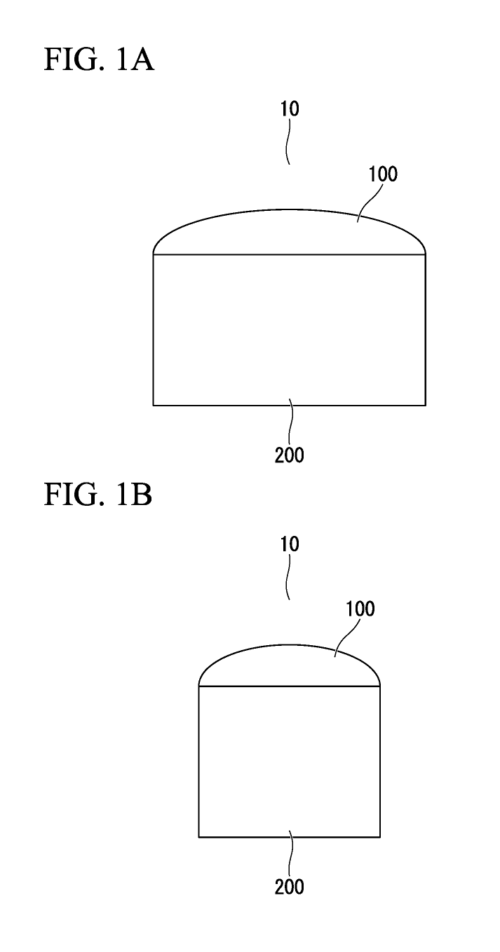

### BEST MODE FOR CARRYING OUT THE INVENTION

The cleaner of the present invention is a cleaning tool for cleaning a connector having unevenness on its end face, and particularly suitable as a cleaning tool for cleaning an optical connector having a fitting pin, a lens or the like projectingly provided on its end face.

Specific examples of such an object to be cleaned include an optical connector (MT connector (F12 type multicore optical fiber connector: JIS C 5981), an MPO connector (F13 type multicore optical fiber connector: JIS C 5982), an MTRJ connector. MPX connector, etc.), and an MXC connector with a lens provided on the end face. Examples other than the optical connector includes a plug having two to three pins projectingly provided thereon to insert into a receptacle socket, and the like.

The cleaner of the present invention has an adhesive body and a holding body configured to hold the adhesive body. The cleaner of the present invention makes it possible to clean an object to be cleaned by pressing the object to be cleaned against the adhesive body. For example, in the case where the object to be cleaned is a connector having a pin projectingly provided on the end face or a connector having a lens provided on the end face of the connector, the end face of the connector having unevenness, namely the object to be cleaned, can be sufficiently cleaned by pressing it against the surface of the adhesive body so that the end face having unevenness follows the adhesive body.

In the present specification, the term “peeling force” refers to a value measured by a method in accordance with JIS Z 2037: 2009, except for the conditions described in the examples and evaluation methods described later.

In addition, the term “hardness” refers to a value measured by a method in accordance with JIS K 6253: 2012 using a type E durometer, except for the conditions described in the examples and evaluation methods described later.

In the present specification, the term “(meth) acryloyl group” is a generic term for acryloyl group and methacryloyl group. The term “(meth) acrylate” is a generic term for acrylate and methacrylate. The term “(meth) acrylic acid” is a generic term for acrylic acid and methacrylic acid.

In addition, the term “holding” refers to a mode in which the adhesive body is fixed on the surface of the holding body, and also refers to a mode in which the adhesive body is fixed to the side surface portion of the holding body when the holding body has a side surface portion.

In the present invention, the term “unevenness provided on the end face of the connector” refers to all kinds of unevenness provided on the end face of the connector, for example, a fitting pin provided on the end face of the connector, an MXC connector having a lens at the end face, or the like.

Hereinafter, embodiments of the present invention will be described in detail.

### First Embodiment

1A and 1B are side views showing an appearance of a cleaner 10 according to an embodiment of the present invention.

The cleaner 10 includes an adhesive body 100 and a holding body 200 configured to hold at least the adhesive body 100, wherein the adhesive body is provided on a surface of the holding body facing an end face of the connector having unevenness (for example, lenses, fitting pin protrusions, etc.) and elastically deformable by contact with the unevenness.

### <Adhesive Body>

The adhesive body 100 is formed in a dome shape on the holding body 20X) to such an extent that it does not peel off from the surface of the holding body during the cleaning operation. The adhesive body 100 may be formed only on the surface the holding body 200 facing the connector, or may extend to a surface adjacent to the surface facing the connector (a side surface of the surface facing the connector).

This adhesive body 100 has a function of removing dust present on an end face of connector including unevenness, such as a surface of ferrule, peripheral surface of guide pin, lens or the like by transferring (moving) the dust to the adhesive body by adhesive force.

The adhesive body in this embodiment can be subjected to compression deformation, expansion deformation, and shear deformation at least by elastic deformation.

When the adhesive body 100 is pressed against the end face having unevenness, the adhesive body 100 temporarily stores a distortion and then releases the stored distortion to deform it so as to approach the unevenness or the end face of the connector. If the stored distortion is sufficient, the adhesive body 100 can be deformed so as to come into close contact with the guide pin, lens, end face of connector, and the like.

The adhesive body in the present embodiment has a peeling force of 0.1 to 10 N/20 mm, more preferably 3.6 to 6.5 N/20 mm. In addition, the hardness thereof is 12 to 52, preferably 17 to 52, and more preferably 22 to 44. If the peeling force and the hardness satisfy the above ranges, when the adhesive body is elastically deformed by being pressed against the end face having unevenness, it is possible to exhibit a resilience against stress and maintain an appropriate adhesive force, and therefore, even in the case of cleaning an end face having unevenness, the dust removability is excellent, amount of adhesive residue is small, and cleaning ability is sufficient. If the peeling force is less than 0.1 N/20 mm, there is a possibility that the dust removability is lowered, the adhesive body is broken, and the adhesive residue tends to be generated, and if it exceeds 10 N/20 mm, there is a possibility that the adhesive residue tends to be generated. In addition, if the hardness is less than 12, there is a possibility that the adhesive residue tends to be generated, and if it exceeds 52, there is a possibility that the dust removability is lowered, the adhesive body is broken, and the adhesive residue tends to be generated.

As an adhesive agent to be used for the adhesive body, it is desirable that it has a repeelability, it does not break even if unevenness is provided on the end face of the connector, and there is no adhesive residue remaining at the time peeling off, there is no peeling occurred or bubble generated in the heat shock test or the like, and it has an elastic deforming force capable of following unevenness and a resilience against stress. Examples of a component of the adhesive agent having such properties include acrylic based resins, rubber type materials typified by butyl rubber, isoprene rubber, styrene butadiene rubber and the like, polyvinyl ether based resin, silicone based resin, urethane based resin and the like, and the adhesive agent can be appropriately selected and used from these examples. The most preferred example is an acrylic based adhesive agent.

For example, in order to obtain an adhesive body from an acrylic adhesive agent, thermal curing, ultraviolet curing or the like may be used, and it is preferable to obtain the adhesive body by ultraviolet curing from the viewpoints of excellent uniformity of elasticity at the time of curing and less residual bubbles. Hereinafter, the adhesive body formed from the acrylic adhesive agent by ultraviolet curing will be described.

An adhesive agent composition used for ultraviolet curing preferably contains a first ultraviolet curable resin and a second ultraviolet curable resin shown below:

By using the first ultraviolet curable resin and the second ultraviolet curable resin in combination, it becomes easy to impart necessary and sufficient dust removability (tackiness) to the adhesive body. In addition, since it is easy to impart appropriate flexibility and elasticity to the adhesive body, for example, when the adhesive body is pressed against a surface having unevenness, the adhesive body can easily follows the shape of unevenness, thereby making it possible to clean an object to be cleaned sufficiently over the details of unevenness. Furthermore, it is easy to improve the adhesive residue remaining property to the end face of connector and the details of unevenness.

The first ultraviolet curable resin is preferably a tacky resin having an acryloyl group and having a molecular weight of less than 200 and being monofunctional. When the first ultraviolet curable resin is monofunctional, a peeling force and hardness of the adhesive body can be kept appropriately, and it is easy to obtain an effect of easily reducing the adhesive residue while securing the dust removability.

The molecular weight of the first ultraviolet curable resin is preferably less than 200, more preferably 190 or less, and still more preferably 185 or less. When the molecular weight is less than 200, adequate adhesiveness can be easily obtained after curing, and the dust removability can be improved. In addition, an adhesive body having moderate flexibility can be obtained, and when a surface having unevenness is pressed against the adhesive body, the adhesive body can follow the shape of the unevenness, thereby cleaning the surface having unevenness easily and sufficiently including the details of unevenness. Although the lower limit of the molecular weight is not particularly limited, it is preferably 100 or more, more preferably 120 or more, still more preferably 140 or more.

The functional group equivalent (acryloyl group equivalent) of the acryloyl group of the first ultraviolet curable resin is preferably less than 200, more preferably 190 or less, and still more preferably 185 or less. When the acryloyl group equivalent is less than 200, the reactivity with the second ultraviolet curable resin, polymerization initiator, ultraviolet curing auxiliary and the like, which will be described later, can be enhanced. Although the lower limit of the acryloyl group equivalent weight is not particularly limited, it is preferably 100 or more, more preferably 120 or more, still more preferably 140 or more.

In the present invention, the acryloyl group equivalent is determined by dividing the molecular weight by the number of acryloyl groups.

The glass transition temperature of the first ultraviolet curable resin is preferably 0° C. or lower, more preferably −40° C. or lower. When the glass transition temperature is 0° C. or lower, the adhesiveness can be enhanced further. Although the lower limit of the glass transition temperature is not particularly limited, is preferably −100° C. or higher, more preferably −80° C. or higher.

In the present invention, the glass transition temperature is measured by a differential scanning calorimeter (DSC).

Examples of the first ultraviolet curable resin include alkyl acrylates such as a methyl acrylate, ethyl acrylate, propyl acrylate, isopropyl acrylate, butyl acrylate, isobutyl acrylate, s-butyl acrylate, t-butyl acrylate, pentyl acrylate, hexyl acrylate, heptyl acrylate, 2-ethylhexyl acrylate, octyl acrylate, isooctyl acrylate, nonyl acrylate, isononyl acrylate or the like; hydroxyalkyl acrylate esters such as a 2-hydroxyethyl acrylate, 2-hydroxypropyl acrylate, 4-hydroxybutyl acrylate or the like; and the like. These resins may be used alone or used in combination of two or more thereof.

Among these resins, a 2-ethylhexyl acrylate and 4-hydroxybutyl acrylate are preferable from the viewpoint of good reactivity in curing.

The second ultraviolet curable resin is a low adhesive resin having a (meth) acryloyl group, and having a molecular weight of 200 or more, and preferably being polyfunctional. When the second ultraviolet curable resin is polyfunctional, the peeling force and hardness of the adhesive body can be kept appropriately, and it is easy to obtain an effect of easily reducing the adhesive residue while securing the dust removability.

The number of (meth) acryloyl groups of the second ultraviolet curable resin is preferably 2 or more, more preferably 2 to 6, and still more preferably 2 to 4. When the number of (meth) acryloyl groups is 2 or more, appropriate flexibility and elasticity can be imparted to the adhesive body. For example, when a surface having unevenness is pressed against the adhesive body, the adhesive body can follow the shape of the unevenness, thereby cleaning the surface having unevenness sufficiently over the details of unevenness. Further, the adhesive residue remaining property to the end face of the connector, guide pin, lens and the like can be further improved.

The molecular weight of the second ultraviolet curable resin is preferably 200 or more, more preferably 220 or more, and even more preferably 350 or more. When the molecular weight is 200 or more, the adhesive residue remaining property to the end face of the connector, guide pin, lens and the like can be further improved. Although the upper limit of the molecular weight is not particularly limited, it is preferably 1,000 or less, more preferably 600 or less, and even more preferably 500 or less.

The functional group equivalent of the (meth) acryloyl group ((meth) acryloyl group equivalent) of the second ultraviolet curable resin is preferably 60 to 140, more preferably 70 to 130, and still more preferably 85 to 115. When the (meth) acryloyl group equivalent falls within the above range, the reactivity with the first ultraviolet curable resin, the polymerization initiator, which will be described later, the ultraviolet curing auxiliary and the like can be enhanced.

The glass transition temperature of the second ultraviolet curable resin is preferably 30 to 120° C., and more preferably 40 to 110° C. When the glass transition temperature falls within the above range, the adhesive residue on the end face of the connector, guide pins, lenses and the like can be further suppressed.

It is preferable that the second ultraviolet curable resin has a rigid structure. If the second ultraviolet curable resin has a rigid structure, it is possible to suppress the adhesive body from being too soft.

Here, the term “rigid structure” means a structure having a low mobility and being difficult to bend by itself. For example, a structure having “—CH₂—CH₂—CH₂—” in the main chain, a structure having two or more crosslinking points, and the like can be mentioned.

Examples of the second ultraviolet curable resin include a 1,4-butanediol di(meth) acrylate, 1,6-hexanediol di(meth) acrylate, neopentyl glycol di(meth) acrylate, pentaerythritol di(meth) acrylate, trimethylolpropane tri(meth) acrylate, pentaerythritol tri(meth) acrylate, pentaerythritol tetra(meth) acrylate, dipentaerythritol hexa(meth) acrylate, glycerin di(meth) acrylate, ethylene glycol di(meth) acrylate, diethylene glycol di(meth) acrylate, triethylene glycol di(meth) acrylate, tetraethylene glycol di(meth) acrylate, polyethylene glycol di(meth) acrylate, propylene glycol di(meth) acrylate, polypropylene glycol di(meth) acrylate and the like. These resins may be used alone or used in combination of two or more thereof.

Among the examples, a 1,4-butanediol di(meth) acrylate, 1,6-hexanediol di(meth) acrylate, neopentyl glycol di(meth) acrylate, pentaerythritol di(meth) acrylate, trimethylolpropane tri(meth) acrylate, pentaerythritol tri(meth) acrylate, pentaerythritol tetra(meth) acrylate, dipentaerythritol hexa(meth) acrylate, glycerin di(meth) acrylate are preferable because they have a rigid structure.

Among the examples, a 1,6-hexanediol diacrylate and pentaerythritol tetraacrylate are more preferable, from the viewpoint of good reactivity during the curing.

The amount of the second ultraviolet curable resin is preferably 0.5 to 3 parts by mass, more preferably 0.75 to 1.5 parts by mass, even more preferably 0.75 to 1 part by mass, with respect to 100 parts by mass of the second ultraviolet curable resin. When the amount of the second ultraviolet curable resin falls within the above range, moderate flexibility is easily imparted to the adhesive body.

The adhesive agent composition may contain a polymerization initiator.

Specific examples of a photopolymerization initiator include radical polymerization initiators such as a benzophenone type, acetophenone type, thioxanthone type, benzoin, benzoin methyl ether or the like; cation polymerization initiators such as an aromatic diazonium salt, aromatic sulfonium salt, aromatic iodonium salt, metallocene compound or the like; and the like. These initiators may be used alone or used in combination of two or more thereof.

Among the examples, a radical polymerization initiator is preferable, and in particular, a benzophenone type is more preferable from the viewpoint of accelerating the curing rate.

The amount of the photopolymerization initiator is preferably 0.1 to 3 parts by mass, more preferably 0.3 to 1.5 parts by mass, even more preferably 0.5 to 5 parts by mass, with respect to 100 parts by mass of the first ultraviolet curable resin.

It is preferable that the adhesive agent composition further contains an ultraviolet curing auxiliary. If the adhesive agent composition further contains an ultraviolet curing auxiliary, curing in the thickness direction of the adhesive body tends to be more uniform. As a result, it becomes easy to obtain an adhesive body having uniform physical properties in the thickness direction. In addition, it becomes easy to impart appropriate flexibility to the adhesive body, and for example, when the guide pin is pushed into the adhesive body, the adhesive body is more likely to follow the shape of the pin. In addition, curing conditions (irradiation conditions of ultraviolet rays) at the time of curing the adhesive agent composition are hardly restricted, and productivity also increases.

As the ultraviolet curing auxiliary, a compound having a thioether bond or a thiol group is preferable, and a compound having a pentaerythritol skeleton is more preferable.

Examples of such a compound include a pentaeythritol tetrakis (3-mercaptobutyrate), methacryloyloxyethoxyethyl isocyanate, and the like. These compounds may be used alone or used in combination of two or more thereof.

Among the examples, a pentaerythritol tetrakis (3-mercaptobutyrate) is more preferable from the viewpoint that the reaction rate is moderate and reactivity can be easily controlled.

The amount of the ultraviolet curing auxiliary is preferably 0.05 to 3 parts by mass, more preferably 0.1 to 1 part by mass, even more preferably 0.1 to 0.5 parts by mass, with respect to 100 parts by mass of the first ultraviolet curable resin. When the amount of the ultraviolet curing auxiliary is not less than the above lower limit, the effect of the ultraviolet curing auxiliary is sufficiently obtained. On the other hand, if the amount of the ultraviolet curing auxiliary is not more than the above upper limit, the adhesive body can be suppressed from becoming too soft.

The adhesive agent composition may contain, if necessary, an ultraviolet curable resin other than the first ultraviolet curable resin and the second ultraviolet curable resin, and known additives such as a tackifier, a filler, a flame retardant, an antistatic agent, a softener, an ultraviolet absorber, an antioxidant, a plasticizer, a surfactant or the like, and the like.

When the adhesive agent composition is cured, a polymer (cured product) of the first ultraviolet curable resin, a polymer (cured product) of the second ultraviolet curable resin, and a copolymer (reaction product) of the first ultraviolet curable resin and the second ultraviolet curable resin are mixed, and it is difficult to determine how the first ultraviolet curable resin reacts with the second ultraviolet curable resin. In particular, when the adhesive agent composition contains an ultraviolet curing auxiliary, since a cross-linked structure is formed, it is difficult to analyze the structure.

In order to form the adhesive body 100, for example, the following method can be adopted.
Dropping the adhesive agent composition for forming the adhesive body 100 on the surface of the holding body 200 of the cleaner 10 and carrying out thermal curing, ultraviolet curing or the like.
Pouring the adhesive agent composition for forming the adhesive body 100 into a tank of the holding body 300 of the cleaner 20 using a preliminary mold and carrying out thermal curing, ultraviolet curing or the like.
Dropping a solution containing the adhesive agent component dissolved in a solvent on the surface of the holding body 200 or pouring the same into a mold for forming the holding body 300, and drying the solvent.

Any other methods other than the above described methods may be used as long as they are capable of forming the adhesive body 100 on the holding body.

### <Holding Body>

Holding body 200 holds the adhesive body 100 on a surface opposed to the end face of the connector. The holding body 200 is formed of a material that is harder than the adhesive body 100. In this embodiment, the surface of the holding body 200 on which the adhesive body 100 is formed is flat, but this surface may have unevenness, or may have depressions or the like so as to easily hold the adhesive body 100.

In the present embodiment, the holding body 200 has a substantially rectangular parallelepiped shape, but the shape of the holding body 200 is not particularly limited, as long as it is in a shape that does not interfere with pressing against the end face of the connector.

By setting the peeling force of the adhesive body 100 to 0.1 to 10 N/20 mm and the hardness to 12 to 52, it is possible to store the distortion necessary for deforming so as to be in close contact with the unevenness or the end face of the connector. By having such characteristics, it is possible to sufficiently clean the connector including the end face of the connector and the details of unevenness and the like.

The holding body in the present embodiment holds the adhesive body at a fixed position. The holding body is formed of a material that is harder than the adhesive body. The holding body may be formed of a material that can stably hold the adhesive body. As such a material, for example, in addition to an acrylic resin, polybutylene terephthalate (PBT) and polyethylene terephthalate (PET), any resin capable of being used as a resin molding material can be used.

in the case where an acrylic resin is used as a material for forming the holding body, acrylic acid ester based and methacrylic acid ester based homopolymers or copolymers can be mentioned. The copolymer may be a random copolymer or a block copolymer.

From the viewpoint of enhancing fluidity at the time of thermal melting, thermal decomposition resistance and compatibility with other additives, preferred examples of the acrylic acid ester based monomer include, for example, acrylic acid alkyl esters such as a methyl acrylate, ethyl acrylate, n-propyl acrylate, isopropyl acrylate, n-butyl acrylate, isobutyl acrylate, tert-butyl acrylate, hexyl acrylate, 2-ethylhexyl acrylate, nonyl acrylate, decyl acrylate, dodecyl acrylate, stearyl acrylate or the like, hydroxyl group-containing acrylic acid alkyl esters such as a 2-hydroxyethyl acrylate, 2-hydroxypropyl acrylate, 4-hydroxybutyl acrylate or the like, a cyclohexyl acrylate, 2-methoxyethyl acrylate, 3-methoxybutyl acrylate, acrylic acid trifluoromethyl, trifluoroethyl acrylate, pentafluoroethyl acrylate, glycidyl acrylate, allyl acrylate, phenyl acrylate, toluyl acrylate, benzyl acrylate, isobornyl acrylate, 3-dimethylaminoethyl acrylate and the like.

Among the acrylic acid ester monomers, acrylic acid alkyl esters are preferred, and acrylic acid alkyl esters in which the alkyl group of the ester moiety has 1 to 4 carbon atoms are more preferred.

Like the above, from the viewpoint of enhancing fluidity at the time of thermal melting, thermal decomposition resistance and compatibility with other additives, preferred methacrylic acid ester based monomers include, for example, a methacrylic acid alkyl ester having an alkyl group with 1 to 18 carbon atoms in the ester moiety such as a methyl methacrylate, ethyl methacrylate, isopropyl methacrylate, n-butyl methacrylate, isobutyl methacrylate, tert-butyl methacrylate, pentyl methacrylate, hexyl methacrylate, heptyl methacrylate, 2-ethylhexyl methacrylate, nonyl methacrylate, decyl methacrylate, dodecyl methacrylate, tridecyl methacrylate, stearyl methacrylate; a cyclohexyl methacrylate, phenyl methacrylate and the like.

Among the above mentioned methacrylic acid esters, because it is readily available, a methyl methacrylate, ethyl methacrylate, n-butyl methacrylate, isobutyl methacrylate, tert-butyl methacrylate, 2-ethylhexyl methacrylate, dodecyl methacrylate, isobornyl methacrylate, cyclohexyl methacrylate, tridecyl methacrylate and stearyl methacrylate are preferred. Further, alkyl methacrylates having an alkyl group with 1 to 4 carbon atoms in the ester moiety is more preferable, and a methyl methacrylate is even more preferable.

In addition, other polymers may be contained in the acrylic acid ester based or methacrylic acid ester based polymer as long as the object of the present invention is not impaired.

Examples of the “other polymers” include an unsaturated monocarboxylic acid such as a methacrylic acid, acrylic acid or the like, a vinyl cyanide compound such as an acrylonitrile, methacrylonitrile or the like, an aromatic vinyl compound such as a styrene, α-methylstyrene, p-methylstyrene, p-methoxystyrene, divinylbenzene, vinyl naphthalene or the like, an unsaturated dicarboxylic acid compound such as a maleic anhydride, maleic acid, maleic acid monoester, maleic acid diester, fumaric acid, fumaric acid monoester, fumaric acid diester or derivative thereof, or the like, a maleimide compound such as a maleimide, methyl maleimide, ethyl maleimide, propyl maleimide, butyl maleimide, hexyl maleimide, octyl maleimide, dodecyl maleimide, stearyl maleimide, phenyl maleimide, cyclohexyl maleimide or the like, a conjugated diene compound such as a butadiene, isoprene or the like, a halogen-containing unsaturated compound such as a vinyl chloride, vinylidene chloride, tetrafluoroethylene, hexafluoropropylene, vinylidene fluoride, chloroprene or the like, a silicon-containing unsaturated compound such as a vinyltrimethoxysilane, vinyltriethoxysilane or the like, and the like. These monomers may be used alone or used by mixing two or more thereof.

A method for polymerizing the above monomers is not particularly limited, and examples of the method include a suspension polymerization method, a bulk polymerization method, and a solution polymerization method.

In addition, an antistatic agent can be added to the resin material constituting the holding body, and a rubber component may be used in combination in order to impart shock resistance, or modifiers such as an aromatic dicarboxylic acid ester, aliphatic dicarboxylic acid ester, phosphoric acid ester or the like may be introduced in order to improve heat resistance.

### Second Embodiment

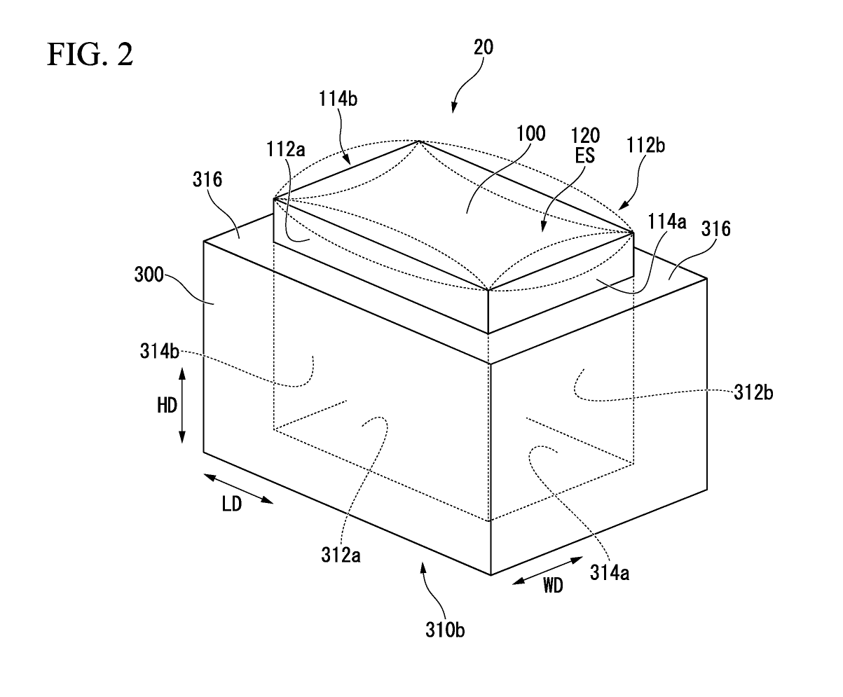

FIG. 2 is a perspective view showing an appearance of a cleaner 20.

This cleaner 20 includes an adhesive body 100 having an exposed portion facing an end face of a connector provided with unevenness (for example, lenses, mating pin protrusions or the like), and a holding body 300 holding the adhesive body 100 in a state where at least the exposed portion is exposed, wherein the adhesive body 100 is elastically deformable by contacting with the unevenness.

### <Adhesive Body>

The adhesive body 100 in the present embodiment can be formed of the same material as the adhesive body 100 in the first embodiment.

The difference between the adhesive body 100 in the first embodiment and the adhesive body 100 in the present embodiment is that the adhesive body 100 in the first embodiment is provided on the upper surface of the holding body 200, while in the present embodiment, the adhesive body 100 is accommodated in the holding body 300, and a part thereof has an exposed portion exposed from the holding body 300. The exposed part faces an end face of the connector. The adhesive body 100 is elastically deformable by contacting with unevenness.

More specifically, the adhesive body 100 of the present embodiment has a substantially rectangular parallelepiped shape, and a part thereof is located in a substantially tank-shaped inner side of the holding body 300. The shape of the portion (a part) exposed from the substantially tank-shaped inner side of the holding body 300 is not limited to a substantially rectangular parallelepiped shape, and any shape such as a dome shape can be taken.

### <Holding Body>

The holding body 300 in the present embodiment can be formed of the same material as the holding body 200 in the first embodiment.

The holding body 300 in the present embodiment accommodates and holds the adhesive body 100. In the present embodiment, the holding body 300 has a holding wall (substantially tank-shaped inner wall) for holding the adhesive body 100. When the adhesive body 100 is held by the holding wall, at least the exposed surface is exposed from the holding body 300. Further, among the surfaces constituting the adhesive body 100, other surfaces than the exposed surface may also be exposed.

More specifically, the holding body 300 has a substantially tank-shape. The holding body 300 has a substantially rectangular inner bottom portion 310b, a substantially rectangular inner side wall portion 312a, a substantially rectangular inner side wall portion 312b, a substantially rectangular inner side wall portion 314a, a substantially rectangular inner side wall portion 314b, and holds the adhesive body 100 in a space formed by them.

The inner side wall portion 312a and the inner side wall portion 312b are provided so as to stand in a substantially vertical direction from the inner bottom portion 310b and face each other across the inner bottom portion 310b. The inner side wall portion 314a and the inner side wall portion 314b are provided so as to stand in a substantially vertical direction from the inner bottom portion 310b and face each other across inner bottom portion 310. In other words, the substantially tank-shape is formed by the inner bottom portion 310b, the inner side wall portion 312a, the inner side wall portion 312b, the inner side wall portion 314a, and the inner side wall portion 314b.

The inner bottom portion 310b, the inner side wall portion 312a, the inner side wall portion 312b, the inner side wall portion 314a, and the inner side wall portion 314b of the holding body 300 can be brought into close contact with a bottom surface portion, a side surface portion 112a, a side surface portion 112b, a side surface portion 114a and a side surface portion 114b of the adhesive body 100.

When the adhesive body 100 is pressed against the unevenness portion, the adhesive body 100 temporarily stores a distortion and releases the stored distortion, so that it is deformed to approach the end face of the connector. If the stored distortion is sufficient, the adhesive body 100 can be deformed so as to be in close contact with the end face of the connector. By setting the peeling force of the adhesive body 100 to 0.1 to 10 N/20 mm and the hardness to 12 to 52, a distortion necessary for deforming to be in close contact with the surface of the guide pin, the lens surface, the connector end face, etc. can be stored. Thereby, it is possible to sufficiently clean the connector including the details of the end face of connector, the surface of lens, and the like.

By the adhesive force of the adhesive body 100, the bottom surface portion, the side surface portion 112a, the side surface portion 112b, the side surface portion 114a, and the side surface portion 114b of the adhesive body 100 can closely contact the inner bottom portion 310b, the inner side wall portion 312a, the inner side wall portion 312b, the inner side wall portion 314a and the inner side wall portion 314b of the holding body 300. Thereby, the holding body 300 can stably hold the adhesive body 100. When the adhesive body 100 is disposed or formed on the holding body 300, an upper surface portion 120 of the adhesive body 100 becomes an exposed surface ES.

An upper end portion 316 is formed at an upper end of the side wall portion 312a, the side wall portion 312b, the side wall portion 314a and the side wall portion 314b of the holding body 300. The heights of the side wall portion 312a, the side wall portion 312b, the side wall portion 314a, and the side wall portion 314b are shorter than the height H of the adhesive body. Therefore, the upper surface portion 120 (exposed surface ES) of the adhesive body 100, the upper portion of the side surface portion 12a, the upper portion of the side surface portion 112b, the upper portion of the side surface portion 114a, and the upper portion of the side surface portion 114b are exposed from the upper end portion 316 of the holding body 300. That is, a part of the adhesive body 100 is provided so as to project from the holding body 300.

As described above, when the cleaner of the present invention is pressed against the end face having unevenness, if the adhesive body 100 is formed on the holding body or projected from the holding body, it can be elastically deformed more freely and flexibly without being restricted by the holding body, and thereby enhancing the ability to follow unevenness and exhibiting high dust removability.

In the example of FIG. 2, when the adhesive body 100 is deformed, depending on the form of deformation, the upper portion of the side surface portion 12a, the upper portion of the side surface portion 112b, the upper portion of the side surface portion 114a, and the upper portion of the side surface portion 114b of the adhesive body 100 may be deformed so as to expand (project) from the outer shape of the holding body 300 or may be deformed so as to contract (deflate) (see the broken line in FIG. 2).

By increasing the deformation easiness and the degree of deformation freedom along the longitudinal direction LD and the width direction WD of the adhesive body 100, when the adhesive body 100 is deformed, the adhesive body 100 can be easily deformed to the details of unevenness. That is, even in a state in which the adhesive body 100 is held by the holding body 300, it is possible to bring the adhesive body 100 into close contact with the details of unevenness by ensuring it without deteriorating the deformation easiness of the adhesive body 100).

In the cleaner 20 of the present embodiment, the holding body 300 is substantially in a tank shape, but the shape of the holding body is not limited thereto, and a holding body having a U-shaped cross section and sandwiching the adhesive body 100 may be used, and any shape can be taken as long as the adhesive body and the holding body are not peeled off during the actual cleaning operation.

Further, in the cleaner 20 of the present embodiment, only one adhesive body 100 is accommodated and held in the holding body 300, but two or more adhesive bodies 100 may be accommodated and held therein. For example, if two adhesive bodies are accommodated and held, it is possible to insert the guide pin into the gap between them and clean it in a short time. Furthermore, it is possible to make a difference in the heights of the two adhesive bodies, thereby making it possible to easily follow the unevenness.

### Third Embodiment

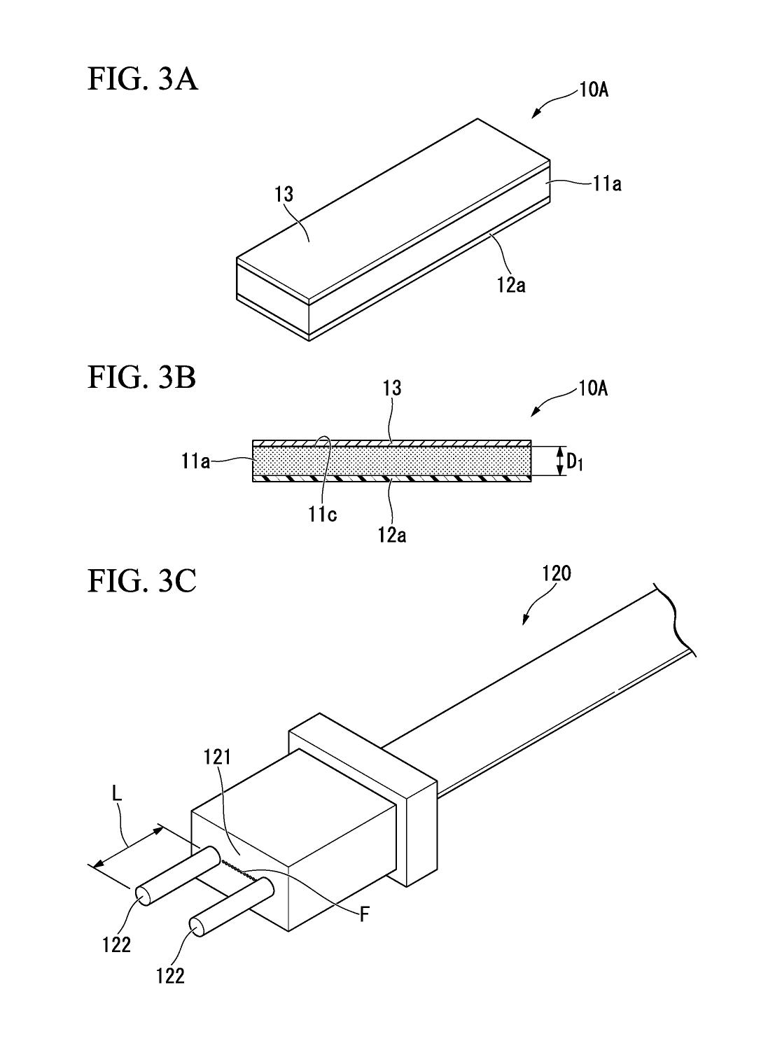

FIG. 3A is a perspective view showing a cleaner of the third embodiment, FIG. 3B is a longitudinal sectional view showing a cleaner of the third embodiment, and FIG. 3C is a perspective view showing an optical connector which is an object to be cleaned. The optical connector 120 illustrated in FIG. 3C is an optical connector in which two fitting pins 122 are projected from the end face 21 (connection end face). The symbol F in FIG. 3C denotes an optical fiber.

The cleaner 10 of the third embodiment includes an adhesive body 11a and a plate body 12a (supporting body) having rigidity, the plate body 12a being stacked on one surface of the adhesive body 11a to support the adhesive body 11a, wherein the cleaner 10 is formed in a portable size and rectangular plate shape. A cover film 13 (cover) is peelably provided on a surface 11c of the adhesive body 11a where the plate body 12a is not provided so as to cover the surface 11c of the adhesive body 11a. The cover film 13 is peeled off when an optical connector 120 is cleaned using a cleaner 10A.

The adhesive body 11a is made of a cured product of an adhesive agent composition.

The adhesive agent composition includes a first ultraviolet curable resin and a second ultraviolet curable resin, which will be described below.

By using the first ultraviolet curable resin and the second ultraviolet curable resin in combination, adequate adhesiveness can be imparted to the adhesive body 11a, and the dust removability can be enhanced. In addition, since an appropriate flexibility and elasticity can also be imparted to the adhesive body 11a, when a fitting pin 122 is pushed into the adhesive body 11a, the adhesive body 11a can follow the shape of the pin, and can be cleaned sufficiently including the peripheral surface of the fitting pin 122. Furthermore, an adhesive residue on the end face and the fitting pin 122 is also suppressed.

The first ultraviolet curable resin is a tacky resin having a (meth) acryloyl group and having a molecular weight of less than 200 and being monofunctional.

The molecular weight of the first ultraviolet curable resin is less than 200, preferably 190 or less, more preferably 185 or less. When the molecular weight is less than 200, adequate adhesiveness can be obtained and the dust removability can be improved. In addition, the adhesive body 11a having moderate flexibility can be obtained, and when the fitting pin 122 is pushed into the adhesive body 11a, the adhesive body 11a can follow the shape of the pin, and the fitting pin 122 as well as the peripheral surface thereof can cleaned sufficiently. The lower limit of the molecular weight is not particularly limited, but it is preferably 100 or more, more preferably 120 or more, still more preferably 140 or more.

The functional group equivalent ((meth) acryloyl group equivalent) of the (meth) acryloyl group of the first ultraviolet curable resin is less than 200, preferably is 190 or less, more preferably 185 or less.

When the (meth) acryloyl group equivalent weight is less than 200, a reactivity with the second ultraviolet curable resin, the polymerization initiator, the ultraviolet curing auxiliary which will be described later, and the like can be enhanced. The lower limit of the (meth) acryloyl group equivalent weight is not particularly limited, but it is preferably 100 or more, more preferably 120 or more, still more preferably 140 or more.

In the present invention, the (meth) acryloyl group equivalent weight is calculated by dividing the molecular weight by the number of (meth) acryloyl groups.

A glass transition temperature of the first ultraviolet curable resin is preferably 0° C. or lower, more preferably −40° C. or lower. When the glass transition temperature is 0° C. or lower, the adhesiveness can be further enhanced. The lower limit of the glass transition temperature is not particularly limited, but is preferably −100° C. or higher, more preferably −80° C. or higher.

In the present invention, the glass transition temperature is measured using a differential scanning calorimeter (DSC).

Examples of the first ultraviolet curable resin include a (meth) acrylic acid alkyl ester such as a methyl (meth) acrylate, ethyl (meth) acrylate, propyl (meth) acrylate, isopropyl (meth) acrylate, butyl (meth) acrylate, isobutyl (meth) acrylate, s-butyl (meth) acrylate, t-butyl (meth) acrylate, pentyl (meth) acrylate, hexyl (meth) acrylate, heptyl (meth) acrylate, 2-ethylhexyl (meth) acrylate, octyl (meth) acrylate, isooctyl (meth) acrylate, nonyl (meth) acrylate, isononyl (meth) acrylate or the like; a (meth) acrylic acid hydroxyalkyl ester such as a 2-hydroxyethyl (meth) acrylate, 2-hydroxypropyl (meth) acrylate, 4-hydroxybutyl (meth) acrylate or the like; and the like. These resins may be used alone or used in combination of two or more thereof.

Among the examples, a 2-ethylhexyl acrylate and 4-hydroxybutyl acrylate are preferable from the viewpoint of good reactivity during the curing.

The second ultraviolet curable resin is a non-tacky resin having a (meth) acryloyl group and having a molecular weight of 200 or more and being polyfunctional.

As the second ultraviolet curable resin, the same resin as the second ultraviolet curable resin used in the cleaner 20 of the first and second embodiments can be used.

The amount of the second ultraviolet curable resin is preferably the same as the amount of the second ultraviolet curable resin used in the cleaner 20 of the first and second embodiments.

Also in the adhesive body of the cleaner of the third embodiment, polymerization initiators, ultraviolet curing auxiliaries and other additives, which are the same as those added to the adhesive body of the cleaner of the first and second embodiments, are contained. The addition amounts thereof are also the same as the addition amounts in the adhesive body of the cleaner of the first and second embodiments.

If necessary, the adhesive body may also contain an ultraviolet curable resin other than the first ultraviolet curable resin and the second ultraviolet curable resin, and other known additives such as a tackifier, a filler, a flame retardant, an antistatic agent, a softener, an ultraviolet absorber, an antioxidant, a plasticizer, a surfactant and the like.

As shown in FIGS. 3A to 3C, the adhesive body 11a of the cleaner 10A of the third embodiment has a thickness (D1) that is equal to or greater than the length (L) of the fitting pin 122 of the optical connector 120.

As the cover film 13, a known resin film or the like which has undergone release treatment for the adhesive body 11a may be used.

In each of the following embodiments, those examples shown here can be used for the adhesive body and the cover film in the same manner.

The plate body 12a having rigidity is made of, for example, a metal plate, a resin plate (a plate made of polyolefin (polypropylene, polyethylene, polycarbonate), amorphous polyester, polyvinyl chloride, polyvinylidene fluoride, nylon or the like), and the thickness is set according to the material properties so that the adhesive body 11a can be stably supported. The plate body 12a does not need to be able to insert the fitting pin 122.

In each of the embodiments described below, those examples shown here can be used for the plate body having rigidity in the same manner.

When cleaning the end face 21 (connection end face) of the optical connector 120 having the fitting pin 122 projectingly provided thereon using the cleaner 10A of the third embodiment, first, the operator releases the cover film 13 of the cleaner 10A to expose the surface 11c of the adhesive body 11a.

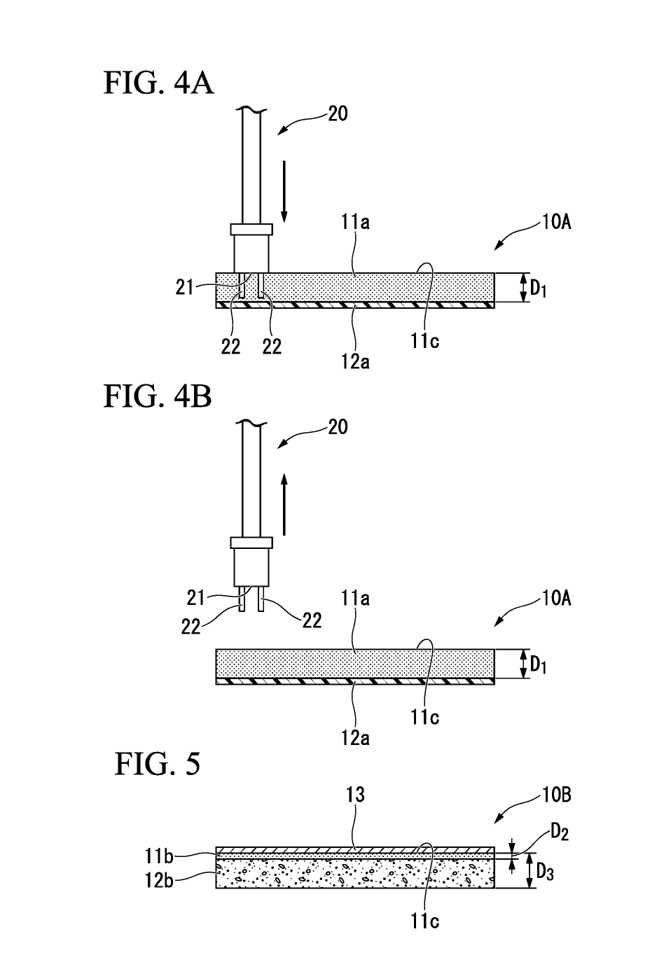

Next, The operator holds the optical connector with one hand and holds the cleaner 10A with the other hand so that the end face 121 of the optical connector 120 approaches the surface 11c of the exposed the adhesive body 11a of the cleaner 10A as shown in FIG. 4A, thereby pushing the fitting pin 122 into the adhesive body 11a and pressing the end face 121 against the surface 11c of the adhesive body 11a. Although the adhesive body 11a at the portion where the fitting pin 122 is pushed is recessed following the shape of the fitting pin 122, since the thickness (D1) of the adhesive body 11a is equal to or longer than the length (L) of the fitting pin 122 of the optical connector 120 in this example, it may seem that the fitting pin 122 sticks to the adhesive body 11a over its entire length in appearance.

Next, as shown in FIG. 4B, the end face 121 of the optical connector 120 is pulled away from the adhesive body 11a, and the fitting pin 122 is pulled out from the adhesive body 11a. When the fitting pin 122 is pulled out from the adhesive body 11a, the recess is removed and returns to the original shape.

In the above cleaning operation, as the end face 121 is pressed against the surface 11c of the adhesive body 11a, dust, dirt and the like adhered to the end face 121 of the optical connector 120 are attached and moved to the surface 11c of the adhesive body 11a. Further, since the adhesive body 11a can follow the shape of the fitting pin 122, dust, dirt and the like adhered to the peripheral surface of the fitting pin 122 are also attached an moved to the adhesive body 11a when the fitting pin 122 is pushed into the adhesive body 11a and then pulled out.

As described above, according to the cleaner 10A of the third embodiment, the operator presses the end face 121 of the optical connector 120 against the adhesive body 11a of the cleaner 10A, and pushes the fitting pin 122 into the adhesive body 11a and pulls it out, thereby being able to remove the dust, dirt and the like adhered to the end face 121 and the peripheral surface of the fitting pin 122 by a simple and quick operation. Therefore, the end face 121 having the fitting pin 122 projectingly provided thereon and the peripheral surface of the fitting pin 122 can be cleaned by a single step operation. In addition, it is possible to suppress the adhesive residue on the end face 121 of the optical connector 120 and the fitting pin 122 after the fitting pin 122 is pulled out from the adhesive body 11a.

Further, the cleaner 10A of the third embodiment is simple in configuration and advantageous in terms of cost.

Further, the cleaner 10A of the third embodiment is formed in a size that can be carried by an operator. For this reason, when an operator finishes the optical connector connection work at a place and moves to another place to perform the optical connector connection work, it is easy for the operator to carry the cleaner 10A and perform cleaning at each place.

In addition, in FIG. 4A, the cover film 13 is completely peeled off so that the entire surface 11c of the adhesive 11a is exposed. However, it is not necessary to peel off the cover film 13 so that the entire surface 11c of the adhesive body 11a is exposed, and it may be partially peeled off as long as the exposed portion of the surface 11c has an area and shape necessary for cleaning the end face 121 of the optical connector 120.

For example, as in this example, when the area of the surface 11c of the adhesive body 11a is sufficiently larger than the area of the end face 121 of the optical connector 120, it is allowable that only a part of the surface 11c of the adhesive body 11a is exposed to perform cleaning operation. After that, the cover film 13 may be returned to the original position to cover the surface 11c of the exposed adhesive body 11a again.

Next, in the case of cleaning an end face 121 of another optical connector 120, the cover film 13 may be partially peeled off again to expose the surface 11c of the adhesive body 11a to perform cleaning operation. In this case, when the amount of dust and dirt adhered to the end face 121 of the optical connector 120 and the fitting pin 122 to be cleaned is small and the degree of contamination is small, plurality of end faces 121 of the optical connector 120 may be cleaned by the same area of the surface 11c of the adhesive body 11a. When the degree of contamination is large, it is preferable to expose a new surface 11c each time cleaning a new optical connector 120 to perform cleaning of the end face 121.

In this manner, a plurality of optical connectors 120 can be cleaned by one cleaner 10A.

In addition, the cover film 13 configured to cover the adhesive body 11a may not be constituted of one piece but may be divided into a plurality of pieces. By adopting such a configuration, it is also possible to peel off a part of the divided plural sheets and expose only a partial area of the adhesive body 11a.

Thereby, when the area of the surface 11c of the adhesive body 11a is sufficiently larger than the area of the end face 121 of the optical connector 120, it is possible to expose only the partial surface 11c of the adhesive body 11a necessary for cleaning the end face 121 of one optical connector 120.

In FIGS. 4A and 4B, the end face 121 of the optical connector 120 is pressed against the surface 11c of the adhesive body 11a in a positional relationship in which the longitudinal direction of the cleaner 10A and the longitudinal direction of the end face 121 of the optical connector 120 are parallel However, it may be pressed so that the longitudinal direction of the cleaner 10A and the short side direction of the end face 121 of the optical connector 120 are parallel to each other, and there is no particular limitation on the positional relationship in the cleaning operation.

Cleaner 10A of the third embodiment can be manufactured by a method of forming an adhesive body 11a on a plate body 12a having rigidity and then disposing a cover film 13 thereon.

The adhesive body 11a can be formed, for example, by applying the above-described adhesive agent composition on the plate body 12a and then irradiating the applied adhesive agent composition with ultraviolet rays to cure the adhesive agent composition.

Also, the adhesive body 11a may be formed on the plate body 12a by, for example, coating an adhesive agent composition on a separately prepared sheet having a transferability, and then irradiating the applied adhesive agent composition with ultraviolet rays to cure the adhesive agent composition to form an adhesive body on the sheet, and then transferring the adhesive body on the plate body 12a.

### Fourth Embodiment

FIG. 5 is a longitudinal sectional view showing a cleaner of the fourth embodiment.

The cleaner 10B of the fourth embodiment includes an adhesive body 11b and a plate body 12b (supporting body) configured to insert a fitting pin 122. The plate body 12b is stacked on one surface of the adhesive body 11b to support the same, and the cleaner 10B is formed in a rectangular plate shape and has a portable size. A cover film 13 (cover) is peelably provided on the surface 11c of the adhesive body 11b not provided with the plate body 12b and covers the surface 11c of the adhesive body 11b.

As the material of the adhesive body 11b in the cleaner of the fourth embodiment, the same material as the adhesive body in the cleaner of the third embodiment can be used.

As shown in FIG. 5, the cleaner 10B of the fourth embodiment is different from the first embodiment in that the adhesive body 11b is formed with a thickness (D2) smaller than the length (L) of the fitting pin 122 of the optical connector 120, and the cleaner 10B of the forth embodiment has a plate body 12b configured to insert the fitting pin 122 as a supporting body.

The thickness (D2) of the adhesive body 11b is preferably 2.0 mm or more.

Examples of the plate body 12b configured to insert the fitting pin 122 include a foamed body of resin such as a polyurethane, ethylene vinyl acetate, polystyrene, polyethylene or the like, a rubber type sponge such as a neoprene, natural sponge or the like, and the like. In this example, the total thickness (D3) of the adhesive body 11b and the plate body 12b configured to insert the fitting pin 122 is set to be not less than the length (L) of the fitting pin 122 of the optical connector 120.

In each of the following embodiments, those examples shown here can be used for the plate body configured to insert a pin such as a fitting pin in the same manner.

In the case of using the cleaner 10B of the fourth embodiment, similar to the cleaner 10A of the third embodiment, the operator can carry it and perform cleaning of the end face 121 of the optical connector 120 having the fitting pin 122 projectingly provided thereon by similar and simple procedures and operation in a short time.

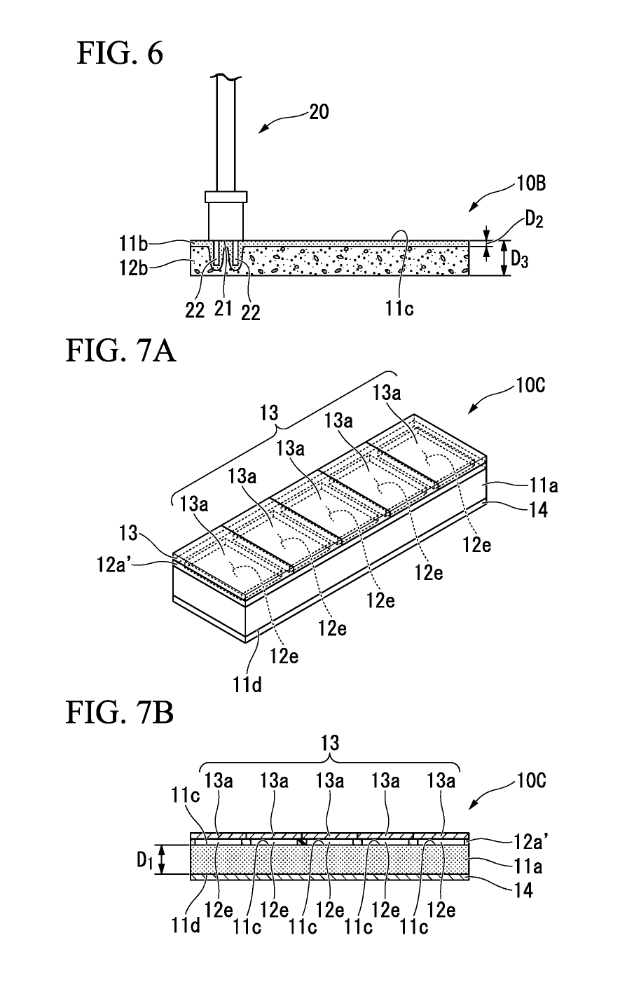

In the cleaner 10B of the fourth embodiment, the thickness (D2) of the adhesive body 11b is smaller than the length (L) of the fitting pin 122. Therefore, in this example, as shown in FIG. 6, when the operator pushes the fitting pin 122 of the optical connector 120 into the adhesive body 11b, the adhesive body 11b at the portion where the fitting pin 122 is pushed into is recessed following the shape of the fitting pin 122. However, even in such a case, dust, dirt and the like adhered to the peripheral surface of the fitting pin 122 attach and move to the adhesive body 11b in a process in which the fitting pin 122 recesses the adhesive body 11b followed by being pulled out.

As in the case of the third embodiment, dust, dirt and the like adhered to the end face 121 of the optical connector 120 attach and move to the adhesive body 11b by pressing the end face 121 against the surface 11c of the adhesive body 11b. As a result, dust, dirt and the like can be removed.

In addition, the plate body 12b at the portion where the fitting pin 122 is pushed into is recessed following the shape of the fitting pin 122, or is formed with a penetrating or non-penetrating hole.

In addition, after the fitting pin 122 is pulled out, the adhesive body 11b returns to the original shape with its recess removed. On the other hand, the plate body 12b is returned to the original shape with its recess removed, and the penetrating hole or the non-penetrating hole is closed. However, in the case where the plate body 12b is made of a polystyrene, when the fitting pin 122 is pushed into and a penetrating or non-penetrating hole is formed, it is difficult to close the hole even when the fitting pin 122 is pulled out.

The cleaner 10B of the fourth embodiment can reduce the amount of the adhesive agent for forming the adhesive body, as compared with the cleaner 10A of the third embodiment. Therefore, the cost required for forming the adhesive body can be suppressed.

In addition, by using a foamed body for the plate body 12b of the cleaner 10B of the fourth embodiment, the sense of use of the cleaner 10B can be improved. That is, when the operator pushes the fitting pin 122, the sense of resistance is reduced, and the clarity of response to the cleaning operation (sense of inserting) can be obtained.

The cleaner 10B of the fourth embodiment can be manufactured by a method of forming the adhesive body 11b on the plate body 12b configured to insert the fitting pin 122, followed by providing the cover film 13 thereon.

Formation of the adhesive body 11b may be carried out in the same manner as in the third embodiment.

In the cleaner 10B of the fourth embodiment, a plate body having rigidity, such as a metal plate, a resin plate or the like, may be further provided on the surface of the plate body 12b configured to insert fitting pin 122 (the surface on the side opposite to the adhesive body 11b).

### Fifth Embodiment

FIG. 7A is a perspective view showing a cleaner of the fifth embodiment, and FIG. 7B is a longitudinal sectional view showing the cleaner of the fifth embodiment.

The cleaner 10C of the fifth embodiment includes an adhesive body 11a and a plate body 12a′ (supporting body) stacked on one surface of the adhesive body 11a to support it, and is formed in a rectangular plate shape having a portable size. The plate body 12a′ has rigidity, and one or more openings 12e are formed in the plate body 12a′. In addition, the surface 11c of the adhesive body 11a is exposed from the opening 12e.

As the material of the adhesive body 11a in the cleaner of the fifth embodiment, the same material as the adhesive body in the cleaner of the fourth embodiment can be used.

In the cleaner 10C of the fifth embodiment, as described above, the fitting pin 122 projecting from the end face 121 of the optical connector 120 is pushed into the surface 11c of the adhesive body 11a exposed from each opening 12e, and the end face 121 is pressed against the surface 11c, thereby making it possible to clean the end face 121 having the fitting pin 122 projectingly provided thereon and the peripheral surface of the fitting pin 122 easily in a short time.

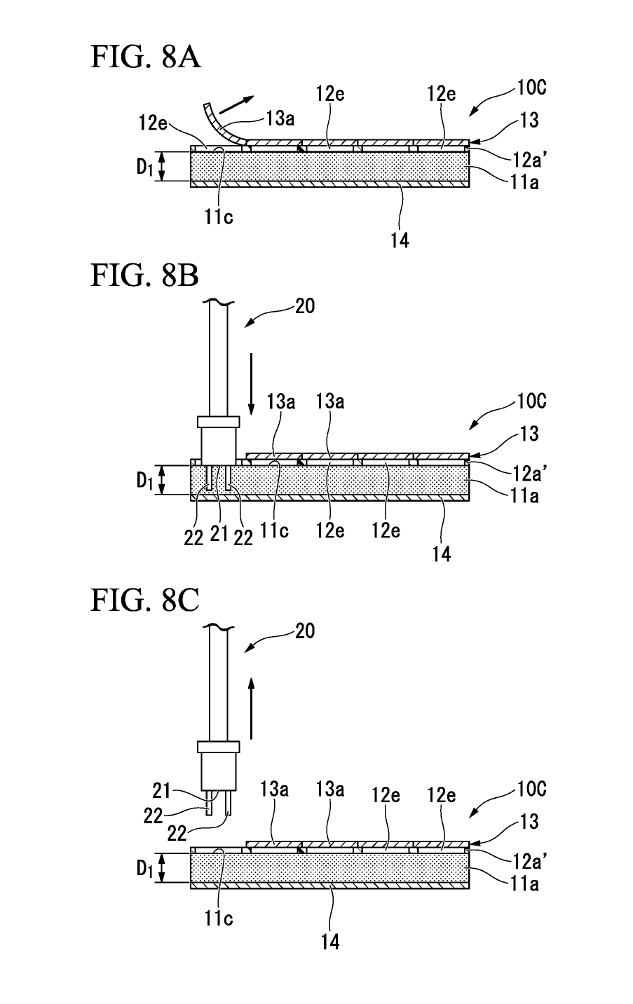

As shown in FIG. 8B, the cleaner 10C of the fifth embodiment includes the adhesive body 11a having a thickness (D1) greater than the length (L) of the fitting pin 122 of the optical connector 120.

The plate body 12a′ has rigidity, and a plurality (five in this example) of openings 12e is formed in a row along the longitudinal direction of the cleaner 10C, and the surface 11c of the adhesive body 11a is exposed from each of the openings 12e. Each of the openings 12e is substantially similar to the end face 121 of the optical connector 120 and is formed in a size slightly larger than the end face 121.

The opening 12e can be formed by a known method such as punching out a plate having rigidity.

As in the case of the third embodiment, the plate body 12a′ of this example is made of a metal plate, a resin plate, etc. and is set to have a thickness according to the material thereof so as to have rigidity to stably support the adhesive body 11a.

The cover film 13 is provided on the surface of the plate body 12a′ on the side where the adhesive 11a is not provided so as to peelably cover the opening 12e. In this example, the cover film 13 is divided into a plurality number (five in this example) so as to correspond to each of the openings 12e. That is, the cover film 13 of this example is divided into five film pieces 13a.

In this example, the surface 11d of the adhesive body 11a on the side where the plate body 12a′ is not provided is not used for the cleaning. For this reason, a coating film 14 configured to cover the adhesive body 11a is unpeelably provided on the surface 11d. The coating film 14 may not have rigidity capable of supporting the adhesive body 11a, and the material thereof and the like are not limited. For example, a resin film, paper, or the like can be used.

In cleaning the end face 21 (connection end face) of the optical connector 120 having the fitting pin 122 projectingly provided thereon by using the cleaner 10C of the fifth embodiment, first, as shown in FIG. 8A, the operator peels off one piece of the film piece 13a located at the end of the cleaner 10C in the longitudinal direction and opens the opening 12e covered with the film piece 13a to expose the surface 11c of the adhesive body 11a.

Subsequently, the operator holds the optical connector with one hand and holds the cleaner 10C with the other hand, and as shown in FIG. 8B, brings the surface 121 of the optical connector 120 close to the surface 11c of the adhesive body 11a exposed from the opening 12e by peeling off the film piece 13a, and pushes the fitting pin 122 into the adhesive body 11a, and presses the surface 121 against the surface 11c of the adhesive body 11a. Although the adhesive body 11a at the portion where the fitting pin 122 is inserted is recessed following the shape of the fitting pin 122, in this example, since the thickness (D1) of the adhesive body 11a is equal to or longer than the length (L) of the fitting pin 122 of the optical connector 120, it may seem that the fitting pin 122 sticks to the adhesive body 11a over its entire length in appearance.

Thereafter, as shown in FIG. 8C, the end face 121 of the optical connector 120 is pulled away from the adhesive body 11a, and the fitting pin 122 is pulled out from the adhesive body 11a. When the fitting pin 122 is pulled out from the adhesive body 11a, the recess is removed and returns to the original shape.

Next, when the end face 121 of another the optical connector 120 is cleaned by using the cleaner 10C, a film piece 13a other than the film piece 13a which has been peeled off earlier (for example, a film piece 13a next to the previously peeled film piece 13a) is peeled off to newly expose a surface 11c of the adhesive body 11a from the opening 12e. Then, the end face 121 of the optical connector 120 is brought close to the surface 11c of the exposed the adhesive body 11a in the same manner as described above to push the fitting pin 122 into the adhesive body 11a, and the end face 121 is pressed against the surface 11c of the adhesive body 11a, and then the fitting pin 122 is pulled out from the adhesive body 11a.

If the amount of dust and dirt adhered to the end face 121 and the fitting pin 122 of the optical connector 120 to be cleaned is small and the degree of contamination is small, the end face 121 of the plurality of optical connectors 120 may be cleaned with the surface 11c of the adhesive body 11a exposed from the same opening 12e. When the degree of contamination is large, it is preferable to newly peel a film piece 13a from another opening 12e to expose a new surface 11c and clean the end face 121.

In this example, the cover film 13 is composed of a plurality of film pieces 13a divided into the same number as the number of the openings 12e so as to correspond to each of the openings 12e, but it is not necessarily to divide the cover film 13.

When not divided, the cover film is partially peeled off so that one opening 12e is opened to expose the surface 11c of the adhesive body 11a, and the end face 121 of the optical connector 120 is pressed against the surface 11c to perform cleaning. After cleaning, the cover film may be returned to the original position to cover the exposed adhesive body again.

As described above, the cleaner 10C of the fifth embodiment is provided with the plate body 12a′ having an opening 12e formed therein as a supporting body, and cleans the end face 121 by pressing the end face 121 of the optical connector 120 against the surface 11c of the adhesive body 11a exposed from the opening 12e and then pressing the fitting pin 122.

If the opening 12e is formed in the plate body 12a′ in this manner, it is possible to guide and urge an operator who is unfamiliar with the cleaning of the end face 121 of the optical connector 120 to press the end face 121 of the optical connector 120 against the surface 11c of the adhesive 11a exposed from the opening 12e. Therefore, even an inexperienced operator can work smoothly without problems.

If the openings 12e are formed in alignment as in this example, it is excellent in workability when cleaning the end faces 121 of the plurality of optical connectors 120 with one cleaner 10C, because it can be sequentially used from the openings 12e at the end, but in some cases, the openings may be randomly arranged. In addition, the openings may be arranged in two or more rows instead of one row, and the number of rows is not limited.

Further, it is preferable that, as in this example, the shape and size of the opening 12e are substantially similar to the end face 121 of the optical connector 120, and the opening 12e is opened with a size slightly larger than the end face 121 from the viewpoint of urging the operator who is unfamiliar with the cleaning operation to press the end faces 121 of the optical connector 120 one by one against the surface 11c of the adhesive body 11a exposed from the opening 12e, but it is not limited to this configuration as long as it is formed in a size and shape capable of pressing an entire surface of at least one end face 121.

Further, the cleaner 10C of this example is also formed in a size that can be carried by an operator. Therefore, in a case where the operator performs the optical connector connecting operation at a certain place and then moves to another place to perform the optical connector connecting operation, etc., it is easy to carry the cleaner 10C and perform the cleaning at each place.

The cleaner 10C of the fifth embodiment can be manufactured by, for example, a method in which the adhesive body 11a is formed on the coating film 14, and the plate body 12a′ having the opening 12e formed thereon and the cover film 13 are laminated in this order thereon. Formation of the adhesive body 11a may be carried out in the same manner as in the third embodiment.

In the cleaner 10C of the fifth embodiment, the coating film 14 may be replaced by a plate body having rigidity (the second supporting body).

Further, in the cleaner 10C of the fifth embodiment, the adhesive body 11a may be formed with a thickness smaller than the length (L) of the fitting pin 122 of the optical connector 120. In this case, it is preferable that the plate body configured to insert the fitting pin 122 is provided on the surface 11d of the adhesive body 11a instead of the coating film 14. Further, a plate body having rigidity such as a metal plate, a resin plate or the like may be further provided on the surface (the surface on the side opposite to the adhesive body 11a) of plate body configured to insert the fitting pin 122. As the plate body configured to insert the fitting pin 122, the same examples shown in the explanation of the cleaner B of the fourth embodiment can be cited.

### Other Embodiments

The cleaner of the present invention is not limited to the embodiments described above.

For example, the shape of the cover configured to cover the exposed surface of the adhesive body is not limited to a film shape, and there is no limitation on the shape as long as it can protect the adhesive body from the dirt, and a lid shape, a cap shape, and the like may be used.

Further, for example, in the cleaner 10A of the third embodiment, the side surface of the adhesive body 11a is exposed in the configuration of FIGS. 3A to 3C, but it is preferable that a frame body or the like is provided around the adhesive body 11a to protect the side surface of the adhesive body 11a from the dirt. In addition, it is also possible to use a configuration provided with the plate body 12a and a side wall portion formed in a manner standing on the periphery of the plate body 12a so as to surround the adhesive body 11a from the side (supporting body in the form of a container) as a supporting body. By using the supporting body in the form of a container, it is also possible to protect the side surface of the adhesive 11a. In the case where the adhesive agent composition is placed on a container-shaped supporting body, it is preferable to fill the container-shaped supporting body with the uncured adhesive agent composition and scrape off the excess adhesive agent composition at the upper end of the side wall portion before curing.

In the second to fifth embodiments as well, the side surface of the adhesive body may be covered with a frame body or the like in the same manner.

In the first to fifth embodiments described above, a rectangular plate-shaped cleaner having a size that can be carried by an operator is exemplified as each of the cleaners 10A to 10C, but the shape is not limited to a rectangle, and it may be a circular shape or the like. Further, the cleaner may have a shape other than a plate shape according to the object to be cleaned, or it may not be a portable size.

Further, the number of pins that the object to be cleaned has on its end face is not limited to two, and may be one or three or more. Further, the shape of the cross section of the pin (the surface orthogonal to the longitudinal direction) is not limited to a circular shape, and may be a polygonal shape, a C shape or the like, and there is no limitation.

Also, the object to be cleaned may not have pins on its end face.

As described above, the present invention has been described with reference to the embodiments, but it should not be understood that the description and drawings constituting a part of this disclosure restrict the present invention. It goes without saying that the present invention includes various embodiments and the like which are not described here.

### Example

Hereinafter, the present invention will be specifically described with reference to examples, but the present invention is not limited thereto.

### [Component]

The compounds used in each example are as follows.

2-EHA: 2-ethylhexyl acrylate (trade name: “2-EHA”, manufactured by Toagosei Co., Ltd., glass transition temperature: −70° C., molecular weight: 184.28, number of functional groups: 1, acryloyl group equivalent: 184.28 g/eq).

4HBA: 4-hydroxybutyl acrylate (trade name: “4HBA”, manufactured by Nippon Kasei Chemical Co., Ltd., glass transition temperature: −40° C., molecular weight: 144.2, number of functional groups: 1, acryloyl group equivalent: 144.2 g/eq).

M-140: N-acryloyloxyethyl hexahydrophthalimide (trade name: “M-140”, manufactured by Toagosei Co., Ltd., glass transition temperature: 56° C., molecular weight: 245.23, number of functional groups: 1, acryloyl group equivalent: 245.23 g/eq).

HDDA: 1,6-hexanediol diacrylate (trade name: “HDDA”, manufactured by Daicel-Ollnex Ltd, glass transition temperature: 105° C., molecular weight: 226, number of functional groups: 2, acryloyl group equivalent: 113 g/eq).

PE-4A: pentaerythritol tetraacrylate (trade name: “Light Acrylate PE-4A”, manufactured by Kyoeisha Chemical Co., Ltd., molecular weight 352.34, number of functional groups: 4, acryloyl group equivalent: 88.085 g/eq).

IB-XA: isobornyl acrylate (trade name: “Light Acrylate IB-XA”, manufactured by Kyoeisha Chemical Co., Ltd., glass transition temperature: 94° C., molecular weight: 208.3, number of functional groups: 1, acryloyl group equivalent: 208.3 g/eq).

Irgacure 184: 1-hydroxycyclohexyl phenyl ketone (trade name: “Irgacure 184”, manufactured by BASF).

MT-PE 1: pentaerythritol tetrakis (3-mercaptobutyrate) (trade name: “Karenz MT-PE 1”, manufactured by Showa Denko KK).

MOI-EG: methacryloyloxyethoxyethyl isocyanate (trade name: “Karenz MOI-EG”, manufactured by Showa Denko K.K.).

Butyl rubber: manufactured by JSR Corporation, trade name: “JSR BUTYL 268”

Isoprene rubber: manufactured by Zeon Corporation, trade name: “Nipol IR 2200”

Styrene butadiene rubber: manufactured by Zeon Corporation, trade name: “Nipol SBR NS 210”

### Example 1

### <Preparation of Adhesive Agent Composition>

100 parts by mass of 2-ethylhexyl acrylate (manufactured by Toagosei Co., Ltd., trade name: “2-EHA”) as the first ultraviolet curable resin, 0.75 parts by mass of 1,6-hexanediol diacrylate (manufactured by Daicel-Omex, trade name: “HDDA”) as the second ultraviolet curable resin, 0.50 parts by mass of 1-hydroxycyclohexyl phenyl ketone (manufactured by BASF, trade name: “Irgacure 184”) as a polymerization initiator were charged in a container and stirred using a stirrer for 5 minutes, and then defoamed for 2 minutes to obtain an adhesive agent composition.

### <Preparation of Adhesive Body>

An adhesive agent composition was filled in a tray (20 mm×90 mm×4 mm), and a polyethylene terephthalate film (PET film: Emblet S50, manufactured by Unitika Ltd.) was laminated on a resin surface, and thereafter the adhesive agent composition was cured to form an adhesive.

The obtained adhesive body was measured and evaluated as follows. The results are shown in Table 1.

### Examples 2 to 17, Comparative Examples 1 to 5

An adhesive agent composition was prepared in the same manner as in Example 1 except that the composition was changed to the composition shown in Tables 1 to 4.

Using the adhesive agent compositions thus obtained, adhesive bodies were produced in the same manner as in Example 1, and various measurements and evaluations were carried out. The results are shown in Tables 1 to 4.

### Example 18

### <Preparation of Adhesive Body>

A butyl rubber (manufactured by JSR Corporation, trade name: “JSR BUTYL 268”) was dissolved in a methyl ethyl ketone to prepare a rubber resin solution. The rubber resin solution was uniformly flowed over a polyethylene terephthalate film (PET film: manufactured by Unitika Ltd., Emblet S50) and the methyl ethyl ketone was dried to obtain an adhesive body of Example 18.

### Example 19

The adhesive body of Example 27 was obtained in the same manner as in Example 19 except that the butyl rubber was changed to an isoprene rubber (trade name: “Nipol IR 2200”, manufactured by Zeon Corporation).

### Example 20

The adhesive body of Example 28 was obtained in the same manner as in Example 20 except that the butyl rubber was changed to a styrene butadiene rubber (manufactured by Zeon Corporation, trade name “Nipol SBR NS 210”).

### <Measurement and Evaluation>

### (Measurement of Hardness)

The PET film was peeled off from the adhesive body sample prepared in the Examples to expose the adhesive, and a rubber hardness tester E (manufactured by Nishi-Tokyo Tokyo Seimitsu Co., Ltd., product name: “WR-107E”) was pressed against the surface of the exposed adhesive body, and the value after 3 seconds was read. The above operation was carried out at 30 places of the adhesive body, and the average value thereof was taken as the rubber hardness E. Evaluation standards are as follows.

### ⊚: Hardness of 22 to 44

### ∘: Hardness of 17 to 52

Δ: Hardness of 12 to less than 17
x: Hardness of less than 12 or exceeding 52

### (Evaluation of Adhesive Residue)

The PET film was peeled off to expose the adhesive body, and an MPO connector with a guide pin was pressed three times under a load of 19.6 N against the surface of the exposed adhesive, and then the connection end face of the optical connector and the peripheral surface of the pin were observed with a microscope.

The above operation was performed on 100 connectors, and the adhesive residue was evaluated according to the following evaluation standards. Regarding the number of defects, if it is 5% or less with respect to the total number, the connector can be used without problems in practical use.

A: Adhesive residue is not observed in all connectors.

B: Adhesive residue is observed in one connector.

C: Adhesive residue is observed in 2 to 3 connectors.

D: Adhesive residue is observed in 4 to 5 connectors.

E: Adhesive residue is observed in 5 or more connectors.

F: Adhesive residue is observed in all connectors.

### (Evaluation of Dust Removability)

After spraying AC Dust Fine (manufactured by Japan Powder Industrial Technology Association) sucked into a dropper on the end face of the connector to be evaluated (MPO connector end face with guide pin), the excess dust was wiped off and 100 samples for evaluation were prepared.

The PET film was peeled off to expose the adhesive body and the sample (MPO connector with guide pin with AC dust Fine adhered thereto) was pressed against the surface of the exposed adhesive body three times under a load of 19.6 N, and then the connection end face of the connector and the peripheral surface of the pin were observed with a microscope.

The above operation was carried out on 30 samples and the dust removability was evaluated according to the following evaluation standards. Regarding the number of defects, if it is 5% or less of the total number, the connector can be used without problems in practical use.

A: Dust is sufficiently removed in all samples.

B: Dust remains in one sample.

C: Dust remains in 2 to 3 samples.

D: Dust remains in 4 to 5 samples.

E: Dust remains in 5 or more samples.

F: Dust remains in all samples.

### (Evaluation of Peeling Force)

The load required for peeling off the PET film (Emblet S50, manufactured by Unitika Ltd.) in the direction of 90° from the samples prepared in the Examples was measured using a Tensilon universal material testing machine RTC-1210A (manufactured by Orientech co., LTD). The above operation was carried out 5 times (N5) per sample, and the average value thereof was taken as the peeling force. Evaluation standards are as follows.

⊚: Peeling force of 3.6 to 6.5 N/20 mm

∘: peeling force of 0.1 to less than 3.6, or more than 6.5 to 10

x: peeling force of less than 0.1 or exceeding 10

Evaluation results of the above evaluation and others are shown in Tables 1 to 5.

TABLE 1

| | | | Example | | | | | |
|---|---|---|---|---|---|---|---|---|
| | | | 1 | 2 | 3 | 4 | 5 | 6 |
| Adhesive agent | The first ultraviolet | 2-EHA | 100 | 100 | 100 | 100 | 100 | 100 |
| composition | curable resin | 4HBA | 0 | 0 | 0 | 0 | 0 | 0 |
| [part by mass] | | M-140 | 0 | 0 | 0 | 0 | 0 | 0 |
| | The second ultraviolet | HDDA | 0.75 | 0.75 | 1.00 | 1.00 | 1.00 | 1.00 |
| | curable resin | PE-4A | 0 | 0 | 0 | 0 | 0 | 0 |
| | | IB-XA | 0 | 0 | 0 | 0 | 0 | 0 |
| | Polymerization initiator | Irgacure184 | 0.50 | 1.00 | 1.00 | 1.00 | 1.00 | 1.00 |
| | Ultraviolet curing auxiliary | MT PE1 | 0 | 0 | 0 | 0.10 | 0.30 | 0.50 |
| | | MOI-EG | 0 | 0 | 0 | 0 | 0 | 0 |

| Rubber hardness E | Measured value | 30 | 22 | 28 | 37 | 20 | 32 |
|---|---|---|---|---|---|---|---|
| | Evaluation result | ⊚ | ⊚ | ⊚ | ⊚ | ◯ | ⊚ |
| Adhesive residue | | A | A | A | A | B | A |
| Dust removability | | A | A | A | A | A | A |
| Peeling force | Measured value | 5.5 | 5.6 | 5.4 | 5.0 | 6.5 | 5.5 |
| (N/20 mm) | Evaluation result | ⊚ | ⊚ | ⊚ | ⊚ | ⊚ | ⊚ |

TABLE 2

| | | | Example | | | | |
|---|---|---|---|---|---|---|---|
| | | | 7 | 8 | 9 | 10 | 11 |
| Adhesive agent | The first ultraviolet | 2-EHA | 100 | 100 | 100 | 100 | 100 |
| composition | curable resin | 4HBA | 0 | 0 | 0 | 0 | 0 |
| [part by mass] | | M-140 | 0 | 0 | 0 | 0 | 0 |
| | The second ultraviolet | HDDA | 1.00 | 1.00 | 1.00 | 1.00 | 1.00 |
| | curable resin | PE-4A | 0 | 0 | 0 | 0 | 0 |
| | | IB-XA | 0 | 0 | 0 | 0 | 0 |
| | Polymerization initiator | Irgacure184 | 1.00 | 1.00 | 1.00 | 1.00 | 1.00 |
| | Ultraviolet curing auxiliary | MT PE1 | 0 | 0 | 0 | 0.10 | 0.20 |
| | | MOI-EG | 0.50 | 1.00 | 1.50 | 0 | 0 |

| Rubber hardness E | Measured value | 42 | 45 | 51 | 33 | 30 |
|---|---|---|---|---|---|---|
| | Evaluation result | ⊚ | ◯ | ◯ | ⊚ | ⊚ |
| Adhesive residue | | B | C | C | A | A |
| Dust removability | | B | D | D | A | A |
| Peeling force | Measured value | 0.8 | 6.8 | 7.8 | 5.7 | 5.5 |
| (N/20 mm) | Evaluation result | ◯ | ◯ | ◯ | ⊚ | ⊚ |

TABLE 3

| | | | Example | | | | | | | |
|---|---|---|---|---|---|---|---|---|---|---|
| | | | 12 | 13 | 14 | 15 | 16 | 17 | 18 | 19 |
| Adhesive agent | The first ultraviolet | 2-EHA | 100 | 100 | 100 | 100 | 100 | 100 | 0 | 100 |
| composition | Curable resin | 4HBA | 0 | 0 | 0 | 0 | 0 | 0 | 100 | 0 |
| [part by mass] | | M-140 | 0 | 0 | 0 | 0 | 0 | 0 | 0 | 0 |
| | The second ultraviolet | HDDA | 0.5 | 0.3 | 0.75 | 0.5 | 0.6 | 0.75 | 1 | 0 |
| | Curable resin | PE-4A | 0 | 0 | 0 | 0 | 0 | 0 | 0 | 1 |
| | | IB-XA | 0 | 0 | 0 | 0 | 0 | 0 | 0 | 0 |
| | Polymerization initiator | Irgacure184 | 1 | 1 | 1 | 1 | 1 | 1 | 1 | 1 |
| | Ultraviolet curing auxiliary | MT PE1 | 0.1 | 0.1 | 0.1 | 0.2 | 0.2 | 0.2 | 0.1 | 0.1 |
| | | MOI-EG | 0 | 0 | 0 | 0 | 0 | 0 | 0 | 0 |

| Rubber hardness E | Measured value | 21 | 18 | 23 | 13 | 16 | 17 | 29 | 26 |
|---|---|---|---|---|---|---|---|---|---|
| | Evaluation result | ◯ | ◯ | ⊚ | Δ | Δ | ◯ | ⊚ | ⊚ |
| Adhesive residue | | B | C | A | D | B | C | A | A |
| Dust removability | | A | C | A | D | B | C | A | A |
| Peeling force | Measured value | 3.6 | 3.5 | 4.2 | 7.1 | 6.3 | 1 | 5.5 | 6.1 |
| (N/20 mm) | Evaluation result | ⊚ | ◯ | ⊚ | ◯ | ⊚ | ◯ | ⊚ | ⊚ |

TABLE 4

| | | Example | | |
|---|---|---|---|---|
| | | 20 | 21 | 22 |
| Adhesive agent composition | | Butyl | Isoprene | Styrene |
| | | rubber | rubber | butadiene |
| | | | | rubber |
| Rubber hardness E | Measured value | 44 | 43.4 | 41.6 |
| | Evaluation result | ⊚ | ⊚ | ⊚ |
| Adhesive residue | | B | B | B |
| Dust removability | | B | B | B |
| Peeling force | Measured value | 9.9 | 0.25 | 0.77 |
| (N/20 mm) | Evaluation result | ◯ | ◯ | ◯ |

TABLE 5

| | | | Comparative Example | | | | |
|---|---|---|---|---|---|---|---|
| | | | 1 | 2 | 3 | 4 | 5 |
| Adhesive agent | The first ultraviolet curable resin | 2-EHA | 100 | 100 | 0 | 0 | 100 |
| composition | | 4HBA | 0 | 0 | 0 | 0 | 0 |
| [part by mass] | | M-140 | 0 | 0 | 0 | 100 | 0 |
| | The second ultraviolet curable | HDDA | 0 | 0 | 100 | 1.00 | 0 |
| | resin | PE-4A | 0 | 0 | 0 | 0 | 0 |
| | | IB-XA | 0 | 0 | 0 | 0 | 1.00 |
| | Polymerization initiator | Irgacure184 | 1.00 | 1.00 | 0.99 | 1.00 | 1.00 |
| | Ultraviolet curing auxiliary | MT PE1 | 0.10 | 0.20 | 0.10 | 0.10 | 0.10 |
| | | MOI-EG | 0 | 0 | 0 | 0 | 0 |

| Rubber hardness E | Measured value | 6 | Unmeasurable | Unmeasurable | 86 | Unmeasurable |
|---|---|---|---|---|---|---|
| | Evaluation result | x | — | — | x | — |
| Adhesive residue | | — | — | — | — | — |
| Dust removability | | — | — | — | — | — |
| Peeling force | Measured value | 52 | — | — | 0.09 | — |
| (N/20 mm) | Evaluation result | x | — | — | x | — |

TABLE 6

| | | | Comparative Example | | | | | |
|---|---|---|---|---|---|---|---|---|
| | | | 6 | 7 | 8 | 9 | 10 | 11 |
| Adhesive agent composition | The first ultraviolet curable resin | 2-EHA | 90 | 70 | 50 | 100 | 100 | 100 |
| [part by mass] | | 4HBA | 0 | 0 | 0 | 0 | 0 | 0 |
| | | M-140 | 0 | 0 | 0 | 0 | 0 | 0 |
| | The second ultraviolet curable resin | HDDA | 10 | 30 | 50 | 0 | 1.00 | 0.3 |
| | | PE-4A | 0 | 0 | 0 | 0 | 0 | 0 |
| | | IB-XA | 0 | 0 | 0 | 0 | 0 | 0 |
| | Polymerization initiator | Irgacure184 | 1.0 | 1.0 | 1.0 | 1.0 | 0.1 | 1.0 |
| | Ultraviolet curing auxiliary | MT PE1 | 0.1 | 0.1 | 0.1 | 0.1 | 0 | 0.2 |
| | | MOI-EG | 0 | 0 | 0 | 0 | 0 | 0 |

| Rubber hardness E | Measured value | 52.4 | 82.4 | 91.8 | 6.8 | 0 | 11 |
|---|---|---|---|---|---|---|---|
| | Evaluation result | x | x | x | x | x | x |
| Adhesive residue | | E | E | F | F | F | E |
| Dust removability | | E | E | F | F | E | E |
| Peeling force | Measured value | 1.2 | 0.1 | 0.0 | 50 or more | 0.1 | 10.5 |
| (N/20 mm) | Evaluation result | ∘ | ∘ | x | x | ∘ | x |

As is apparent from the results of Tables 1 to 6, the adhesive body obtained in each example was excellent in dust removability, and the adhesive residue was also within a range where there was no problem in terms of practical characteristics.

On the other hand, the adhesive body obtained in Comparative Example 1 had an insufficient hardness. Therefore, it was judged as that it was unworthy of evaluation, and the evaluation of dust removability and adhesive residue was not carried out in Comparative Example 1.

In the adhesive body obtained in Comparative Example 2, the PET film could not be peeled off from the adhesive body. Therefore, the measurement of rubber hardness and peeling force, evaluation of the adhesive residue and dust removability could not be carried out.

The adhesive bodies obtained in Comparative Examples 3 and 4 were too hard. For that reason, it was impossible to evaluate the adhesive residue and dust removability. In particular, since the hardness of the adhesive body obtained in Comparative Example 3 was too high, the rubber hardness could not be measured.

In the adhesive body obtained in Comparative Example 5, the PET film could not be peeled off from the adhesive body. Therefore, the measurement of rubber hardness and peeling force, evaluation of the adhesive residue and dust removability could not be carried out.

### EXPLANATION OF SYMBOLS

10, 20, 10A to 10C Cleaner
200, 300 Supporting body
11a, 11b, 100 Adhesive body
11c Surface of adhesive body
11d Surface of adhesive body (on the side where no plate is provided)
12a Plate (having rigidity)
12a′ Plate body (having rigidity and formed with opening)
12b Plate body (configured to insert pin)
12e Opening
13 Cover film (cover)
13a Film piece
14 Coating film
120 Optical connector
121 End face of optical connector
122 Fitting pin

1. A cleaner comprising an adhesive body and a holding body configure to hold the adhesive body, wherein
a peeling force of the adhesive body is 0.1 to 10 N/20 mm and a hardness of the adhesive body is 12 to 52.

2. The cleaner according to claim 1, wherein the adhesive body is provided on a surface of the holding body.

3. The cleaner according to claim 1, wherein the adhesive body is configured to be held so that a part of the surface of the adhesive body is exposed.

4. The cleaner according to claim 1, wherein the adhesive body is a cured product of an adhesive agent composition containing a first ultraviolet curable resin having an acryloyl group and being monofunctional, and a second ultraviolet curable resin having a (meth) acryloyl group and being polyfunctional.

5. The cleaner according to claim 4, wherein a molecular weight of the first ultraviolet curable resin is less than 200 and a molecular weight of the second ultraviolet curable resin is 200 or more.

6. The cleaner according to claim 1, wherein the adhesive body is a cured product of an adhesive agent composition containing a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.

7. The cleaner according to claim 4, wherein the adhesive agent composition further contains an ultraviolet curing assistant.

8. The cleaner according to claim 1, wherein the cleaner is used for cleaning an end face of optical connector.

9. The cleaner according to claim 8, wherein unevenness is provided, or a pin is projected on the end face of optical connector.

10. A method for manufacturing a cleaner, comprising
a step of disposing an adhesive agent composition on a holding body and irradiating ultraviolet rays to cure the adhesive agent composition to form an adhesive body on the holding body, wherein
the adhesive agent composition comprises a first ultraviolet curable resin having an acryloyl group and being monofunctional, and a second ultraviolet curable resin having a (meth) acryloyl group and being polyfunctional.

11. A method for manufacturing a clear, comprising
a step of applying an adhesive agent composition on a sheet having a transferability and curing the adhesive agent composition by irradiating ultraviolet rays to form an adhesive body on the sheet, and
a step of transferring the obtained adhesive body on a holding body, wherein
the adhesive agent composition comprises a first ultraviolet curable resin having an acryloyl group and being monofunctional, and a second ultraviolet curable resin having a (meth) acryloyl group and being polyfunctional.

12. A method for manufacturing a cleaner, comprising
a step of disposing an adhesive agent composition on a holding body and curing the adhesive agent composition by irradiating ultraviolet rays to form an adhesive body on the holding body, wherein
the adhesive agent composition comprises a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.

13. A method for manufacturing a cleaner, comprising
a step of applying an adhesive agent composition on a sheet having a transferability and curing the adhesive agent composition by irradiating ultraviolet rays to form an adhesive body on the sheet, and
a step of transferring the obtained adhesive body on a holding body, wherein
the adhesive agent composition comprises a first ultraviolet curable resin having a (meth) acryloyl group and having a molecular weight of less than 200 and being monofunctional, and a second ultraviolet curable resin having a (meth) acryloyl group and having a molecular weight of 200 or more and being polyfunctional.
